(19) United States
(12) Patent Application Publication
(10) Pub. No.: US 2019/0360690 A1
(43) Pub. Date: Nov. 28, 2019

(54) INLET ARRANGEMENT FOR COLLECTION OF CARRY OVER FOR A VERTICAL REGENERATOR OF AN END-PORT FURNACE

(71) Applicant: Refractory Intellectual Property GmbH & Co. KG, Wien (AT)

(72) Inventors: Elias Carrillo Bañuelos, Benito Juarez, Mexico City (MX); Stefan Postrach, Mainz (DE)

(21) Appl. No.: 16/484,774

(22) PCT Filed: Mar. 26, 2018
(86) PCT No.: PCT/EP2018/057617

§ 371 Date: Aug. 8, 2019

(30) Foreign Application Priority Data
Mar. 29, 2017 (EP) 17163482.7

(51) Int. Cl. F23L 15/02; F28D 17/02

(52) U.S. Cl. CPC F23L 15/02; C03B 5/237; F28D 17/02

(57) ABSTRACT

The invention relates to a regenerator assembly and an inlet arrangement for collection of carry over (10) for a vertical regenerator (80) of an end-port furnace (90) comprising:
an inlet wall comprising an opening for a port for gas exchange, e.g. towards or from an end-port furnace;
a target wall being arranged such, that most of the via the inlet wall incoming hot gas is initially deflected at the target wall;
a barrier wall comprising a recess for gas exchange, e.g. from or towards a pass of the regenerator,
a (at least one) delimiting wall or walls, such as a floor and/or a roof and/or a sidewall;
the inlet wall, the target wall, the barrier wall and the delimiting wall or walls define the inlet arrangement for collection of carry over such that a gas flow entering the inlet arrangement for collection of carry over via the port will exit the inlet arrangement for collection of carry over via the recess or vice versa;
and the ratio between the area of the barrier wall and the total area in the plane of the barrier wall, limited by the delimiting wall or walls, such as the floor, the roof, the inlet wall and the target wall, is in the range of 20% to 40%.

### FIELD

The invention relates to an inlet arrangement for collection of carry over for a vertical regenerator of an end-port furnace and a regenerator assembly comprising an inlet arrangement for collection of carry over and a vertical regenerator.

### BACKGROUND

State of the art single pass or double pass regenerators for end-port furnaces, as used in the glass industry, comprises two regenerator chambers (each chamber can comprise one or more passes) in which checkerwork (or just checkers) of refractory bricks has been stacked. Commonly used materials for checkerwork bricks are refractory bricks comprising magnesia or AZS (alumina-zirconia-silica) fused cast materials.

Such a regenerator is exemplary disclosed in US 2015/0210581 A1.

A recuperator for an open-hearth furnace comprising a so called slag pocket is described in GB 452 524 A.

The background state of the art is described in the book by Wolfgang Trier “Glasschmelzöfen—Konstruktion and Betriebsverhalten”, 1984, Springer Verlag in Chapter 3.

### SUMMARY OF THE INVENTION

This invention relates to the modern design of vertical regenerators with vertical chambers (“stehende Kammer”), where the main flow direction of the gas in the regenerator chambers is in the vertical direction. Only such designs allow to have a short connection to the furnace (called “port”) and also allow to raise the upper level of checkers, which increases thermal efficiency (see e.g. Trier's book, page 35).

Regenerators are used to store waste heat from combustion cycles and re-use this heat for pre-heating the combustion air.

Therefore the checkers are heated up by flue gases from the furnace in one cycle (heat up cycle). In other words, the exhaust gases from the furnace are guided through the checkerwork structure, where they transfer part of their (heat) energy to the checkers. In that way the checkerwork structure is heated up and energy is stored.

In the next stage the direction of gas stream is reversed and the formerly heated checkers now transfer (heat) energy to the gas stream, thus the combustion air is preheated (reverse cycle). In other words: for the reverse cycle, an external fresh air stream is flowing in opposite direction of the flue gas flow during the heat up cycle and the formerly heated checkers are now cooled down and thereby transfer (heat) energy to this fresh air stream, thus this gas stream (the combustion air) is preheated (reverse cycle).

For an efficient heat recovery short distances between the furnace and the regenerator are needed, therefore the end-port furnace is often situated near to and at approximately the same height as the port of the regenerator. Also the gas stream should be able to flow without any restrictions between the furnace and the entry of the regenerator, to minimize energy loss. Although modern vertical regenerators have a very good efficiency for heat recovery, the direct flow of flue gases into the checkers leads to refractory corrosion and damages (such as plugging) due to deposition of solid components from the flue gas and condensation of volatile products present in the flue gas, which condense and are then deposited on the surfaces of the checker work. Such corrosion or plugging can be caused by repeated solidifying and melting of condensed alkali vapors, such as for example sodium sulfate. Also dust deposits can block or constrain flow passages and subsequently lead to local high pressure drops and decreased heat transfer between the gas stream and the checkers resulting in a reduced efficient checker volume. All these depositions (in summary often termed “carry over”) result in the need for a regular maintenance of the whole regenerator checkerwork, which is costly and the used cleaning processes are hazardous (e.g. one method externally heats up all checkers to a temperature, where carry over such as sulphates are melting, in which case one must handle quite large amounts of hazardous molten sulfates). Also the thermal efficiency of the regenerator is reduced due to the reduced heat transfer between the gas and the checkers, due to deposits on the checkers acting as an insulation layer or due to blocked passageways.

One object of the invention is to separate and collect carry over (such as particles and/or dust) from a hot gas, thereby optimizing the regeneration of gases containing carry over.

Another object of the invention is to reduce waste deposition in checkers, thereby increasing lifetime and efficiency of regenerators.

The object is achieved by providing an inlet arrangement for collection of carry over according to claim 1 and a regenerator assembly according to claim 13.

The term “inlet arrangement for collection of carry over” is to be understood as an arrangement (or alternatively a chamber) suitable for the separation and storage of carry over (such as particles or dust) from a hot gas, e.g. a flue gas from an end-port furnace, where such particles or dust are present. The term hot gas in connection with this invention should be understood to be a gas with a temperature in the range of 1100 to 1550° C.

In one embodiment the object is achieved by providing an inlet arrangement for collection of carry over for vertical regenerator of an end-port furnace comprising:
an inlet wall comprising an opening for a port for gas exchange, e.g. towards or from an end-port furnace;
a target wall being arranged such, that most of the via the inlet wall incoming hot gas is initially deflected at the target wall;
a barrier wall comprising a recess for gas exchange, e.g. from or towards a pass of the regenerator,
a (at least one) delimiting wall or walls, such as a floor and/or a roof and/or a sidewall;
the inlet wall, the target wall, the barrier wall and the delimiting wall or walls define the inlet arrangement for collection of carry over such that a gas flow entering the inlet arrangement for collection of carry over via the port will exit the inlet arrangement for collection of carry over via the recess or vice versa;
the ratio between the area of the barrier wall and the total area in the plane of the barrier wall, limited by the delimiting wall or walls, such as the floor, the roof, the inlet wall and the target wall, is in the range of 20% to 40%.

Preferably the delimiting walls comprise a floor, a roof and a sidewall, in which case one embodiment of the inlet arrangement for collection of carry over for a vertical regenerator of an end-port furnace comprises:
an inlet wall with an opening for a port for gas exchange towards an end-port furnace,
a floor,
a target wall being arranged such, that most of the via the inlet wall incoming hot gas is initially deflected at the target wall,
a barrier wall comprising a recess for gas exchange towards a pass of the regenerator,
a roof,
a sidewall,
   the inlet wall, the floor, the roof, the sidewall, the target wall, the barrier wall defining the inlet arrangement for collection of carry over such that a gas flow entering the inlet arrangement for collection of carry over via the opening for the port will exit the inlet arrangement for collection of carry over via the recess or vice versa.

Preferably the floor builds a bottom surface, the roof builds a top surface and the sidewall, the inlet wall, the target wall and the barrier wall build sideward surfaces that define and delimit the volume of the inlet arrangement for collection of carry over.

During the heat up cycle a gas stream of hot gas (e.g. hot flue gas) with particles and dust can enter the inlet arrangement for collection of carry over through the opening for a port of the inlet wall. The port can be directly connected to an end port furnace. The port has preferably no obstacles or bends, to allow an efficient and direct gas stream. In other words, the port should have constant (or alternatively only slowly varying) cross section (in planes normal to the direction of gas flow) or at least no abrupt changes of cross-section or abrupt bends that cause a change of the direction of the gas flow. The port is preferably a horizontal port, that is it has a horizontal bottom surface. The opening for a port is preferably a vertical opening or in other words the opening is an opening of a vertical wall. The target wall is preferably arranged such, that most of the via the inlet wall incoming hot gas (for example more than 90 weight % of the whole incoming hot gas) is initially deflected at the target wall, or alternatively, the target wall is arranged such that the direction of the port (defined by the mean flow direction of the gas inside the port) points at the target wall. The particles and the dust will hit the target wall and loose most of their momentum upon that hit. It was observed that with the inventive setup, a high amount of the particles and dust will simply fall to the floor side of the inlet arrangement for collection of carry over. The hot flue gas with significantly reduced number of particles or dust will exit the inlet arrangement for collection of carry over via the recess of the barrier wall. The barrier wall will prevent that particles or dust on the floor side of the inlet arrangement for collection of carry over can exit/go outside the inlet arrangement for collection of carry over via the recess. The recess defines an opening in the barrier wall. By separately providing a target wall and a barrier wall such an inlet arrangement for collection of carry over thus has the advantage of separating the gas stream from particles and dust. In case the inlet arrangement for collection of carry over is used at the entry of a regenerator, corrosion and damage of the checkers of the regenerator is greatly reduced, leading to longer maintenance intervals and to higher energy efficiency. In this setup also back transfer of accumulated carry over via the port to the end port furnace is minimized, as it was found that back transport of carry over cumulated at the bottom of the barrier wall is very low.

All walls (such as the inlet wall, the floor, the roof, the sidewall, the target wall, the barrier wall) of the inlet arrangement for collection of carry over can comprise or even be entirely made of bricks made from mullite or silica or magnesia, fused cast AZS, zirconia-mullite, chrome-alumina, because of their high corrosion resistance and their good thermal stability at high temperatures.

Preferably the inlet wall, the target wall, the barrier wall and the sidewall of the inlet arrangement for collection of carry over are vertical walls. Preferably the floor, the inlet wall, the target wall, the barrier wall and the sidewall of the inlet arrangement for collection of carry over are planar walls. Preferably the roof is an arched roof.

Preferably the floor, the inlet wall, the target wall, the barrier wall and the sidewall of the inlet arrangement for collection of carry over are aligned to each other in a regular rectangular form, or in other words, each wall can be arranged at an angle of 90° to each neighboring wall, in which case the inside of the inlet arrangement for collection of carry over resembles a cuboid (with an arched roof).

Preferably the neighboring walls of the inlet wall and of the target wall are the sidewall and the barrier wall. Preferably all neighboring walls are connected with each other and all walls are connected with the floor and the roof.

One exemplary way of arranging the target wall such that most of the via the inlet wall incoming hot gas is initially deflected at the target wall is described in the following: The target wall is arranged opposite of the inlet wall. Preferably the target wall is arranged at an angle, especially an horizontal angle, of between 80° to 100° relative to the direction defined by the port (i.e. the main gas flow direction in the port near the entry to the inlet arrangement for collection of carry over) or by the normal vector of the inlet wall. This has the effect, that most of the incoming gas flow via the inlet wall is initially guided directly towards the target wall. The barrier wall (containing the recess for the exit of the gas during the heat cycle) is arranged at an angle, especially an horizontal angle, of between 80° to 100° relative to the target wall. In that way the gas flow will make a (horizontal) bend (in other words: will be deflected) inside the inlet arrangement for collection of carry over towards the barrier wall and will exit the inlet arrangement for collection of carry over via the recess in the barrier wall. Any particles inside the gas flow will keep a part of their initial trajectory towards the target wall and thus will be separated from the gas flow.

Preferably the inlet arrangement for collection of carry over comprises at least one hole for cleaning in the target wall. Such a hole has a cross section generally in the form of a square, (alternatively as a rectangle or a circle) and has preferably side lengths (or a diameter in the case of a circle) in the range of 250 mm to 700 mm, preferably 500 mm to 700 mm. It allows access from the outside to the inlet arrangement for collection of carry over for easy cleaning operation, especially to the area on the floor near the target wall, which is where most carry over will settle. Preferably the target wall comprises 1 to 3 cleaning holes. In operation the cleaning holes are closed by putting a refractory plug into the cleaning holes and sealing the plug, e.g. with mortar.

The barrier wall and the target wall are preferably connected along one corner of the inlet arrangement for collection of carry over. In other words, the target wall and the barrier wall build adjacent sidewalls of the inlet arrangement for collection of carry over with a common corner.

Preferably the connection between the target wall and the barrier wall is along the full height of one corner of the inlet arrangement for collection of carry over. In other words there is no recess in the barrier wall at the corner of the barrier wall adjacent to the target wall or alternatively the height of the recess at the corner of the barrier wall adjacent to the target wall is approaching zero/is virtually zero. This reduces gas flow velocity at the floor of the inlet arrangement for collection of carry over near the corner of the target wall and the barrier wall, which is where most of the dust particles settle. Therefore this setup achieves a further reduced amount of dust particles carried out by a gas stream. Additionally this setup further minimizes back transfer of accumulated carry over via the port to the end port furnace during the reverse cycle.

The barrier wall defines a solid barrier with a certain cross section area in the direction of gas flow. The barrier wall comprises a recess, where gas can enter or exit the inlet arrangement for collection of carry over. Therefore a surface area of the barrier wall alone (A(wall)), of the recess alone (A(recess)) and an overall surface in the plane of the barrier wall including the area of the recess (A(total)=A(wall)+A(recess)) can be calculated. In other words, A(total) corresponds to the area in the plane of the barrier wall defined (or limited) by the delimiting wall or walls (such as the floor and the roof), the inlet wall, and the target wall. Preferably the ratio R between the area of the barrier wall (A(wall)) and the total area in the plane of the barrier wall (A(total)), R=A(wall)/A(total) is in the range of 20% to 40%, preferably in the range of 28% to 38%. At values lower that 20% it was found that the barrier wall does not sufficiently retain dust particles inside the inlet arrangement for collection of carry over as there is not sufficient space inside the inlet arrangement for collection of carry over formed, that is a space where the gas stream velocity is reduced. At a ratio above 40% it was found that the gas stream velocity is increased at the recess such that highly turbulent gas flow regions build up inside the inlet arrangement for collection of carry over. Such turbulent regions lead to a raise up of dust previously settled on the floor and prevent settling of new dust on the floor. Best results were obtained at R in the range of 28% to 38%.

The barrier wall preferably defines a triangular barrier.

The triangular barrier can be preferably in the form of a flat, right-angled triangle, where the right angle of the triangle is in the corner of the target wall and the floor. In other words, the legs (catheti with length a and b) of the right angled triangle are aligned on the floor and on the target wall, respectively and the hypotenuse (side with length c) builds the upper border of the triangular barrier. The legs are thus defining a length a and a length b of the right angled triangle with an area of A(wall)=(a·b)/2.

Preferably one leg/the first leg (cathetus of length a) of the right-angled triangle is aligned along the target wall, in a direction defined by a vertical angle in the range of 80° to 100° to the floor of the inlet arrangement for collection of carry over, preferably perpendicular to the floor of the inlet arrangement for collection of carry over, and has a length a equal to the height of the inlet arrangement for collection of carry over in the corner between the target wall and the barrier wall. In other words, the height (length a) of the right angled triangle equals the height of the inlet arrangement for collection of carry over in the corner defined by the intersection of the target wall and the barrier wall.

Preferably one leg/the second leg (cathetus of length b) of the right angled triangle is aligned along the floor of the inlet arrangement for collection of carry over, in a direction defined by a horizontal angle in the range of 80° to 100° to the target wall, preferably perpendicular to the target wall. Preferably this leg (cathetus b) has a length b in the range of 70% to 80% (even more preferably in the range of 73% to 77%) of the depth of the inlet arrangement for collection of carry over measured along the intersecting line between the barrier wall with the floor. In other words the length b of the right angled triangle lies in the range of 70% to 80% (even more preferably in the range of 73% to 77%) of the depth of the inlet arrangement for collection of carry over measured along the intersecting line between the barrier wall with the floor. In these ranges a good (the best) result concerning thermal efficiency was achieved, probably due to a favorable gas stream distribution together with very low reverse transport of accumulated carry over to the end port furnace during the reverse cycle.

Preferably the floor of the inlet arrangement for collection of carry over is at a lower elevation than the bottom edge of the opening for the port. In other words, a step is introduced between the floor of the inlet arrangement for collection of carry over and the bottom edge of the opening for the port. This further prevents that collected dust can exit the inlet arrangement for collection of carry over during the reverse cycle via the port, e.g. when the gas stream is entering the inlet arrangement for collection of carry over via the recess and exiting the inlet arrangement for collection of carry over via the opening for the port. In combination with a triangular barrier, the step height can be quite small to achieve this object. The height of the step is preferably in the range 50 cm to 90 cm, more preferably in the range of 70 cm to 90 cm.

Another embodiment achieves the object of the invention by providing a regenerator assembly comprising an inlet arrangement for collection of carry over as described above and a vertical regenerator.

The vertical regenerator is preferably a single pass or a double pass vertical regenerator.

A single pass vertical regenerator comprises a first (and only) vertical pass.

For a single pass vertical regenerator the inlet arrangement for collection of carry over is preferably arranged such, that the barrier wall of the inlet arrangement for collection of carry over is built by a sidewall of the regenerator housing. The recess of the barrier wall is thus also a recess of the sidewall of the regenerator housing. Thus gas entering the inlet arrangement for collection of carry over via the opening for the port is guided through the inlet arrangement for collection of carry over and exits the inlet arrangement for collection of carry over at the recess and through the first (and only) pass of the regenerator and exits the regenerator through the canal, when the regenerator is in the heating cycle. The support for the floor of the inlet arrangement for collection of carry over can be easily constructed, e.g. by a steel construction outside (below) the inlet arrangement for collection of carry over.

A double pass vertical regenerator comprises two vertical passes, namely a first pass and a second pass. The two passes are connected by a connection channel (also called flue) situated near the bottom of the regenerator.

For a double pass vertical regenerator, preferably the floor of the inlet arrangement for collection of carry over is arranged on top of a first pass (e.g. the short pass) of the double pass vertical regenerator and inside the housing of the double pass vertical regenerator. In other words the roof of the inlet arrangement for collection of carry over is built by the roof of the regenerator and the sidewalls of the inlet arrangement for collection of carry over build the walls of the regenerator delimiting the first pass and the division (delimiting) wall separating the first pass and the second pass of the regenerator. Thereby the inlet arrangement for collection of carry over is arranged such, that the first interaction of the hot flue gas (entering the regenerator via the opening for a port) with the regenerator is happening in the inlet arrangement for collection of carry over. This setup has the advantage that heat losses are minimized or in other words, that heat exchange can be maximized.

For a double pass vertical regenerator, the inlet arrangement for collection of carry over is preferably arranged on top of a first pass (e.g. the short pass) and below the roof of the regenerator by being built on a support which is connected to the housing of the regenerator. In that way the inlet arrangement for collection of carry over is arranged (or in other words confined) fully inside the housing of the regenerator, and heat losses are minimized and regeneration efficiency is optimized.

For a double pass vertical regenerator, the preferred support are ceramic tubes or a sub crown structure. In other words the floor of the inlet arrangement for collection of carry over rests on top of a support such as ceramic tubes or a sub crown structure.

The sub crown structure has an advanced stability for use in larger regenerators (e.g. for regenerators with a depth above 4.5 m). Heat losses are further prevented, as no cooling is needed in that case. The sub crown structure is preferably bearing on skew back bricks fixed on regenerator housing on the inlet wall side and on the target wall side.

For the support being ceramic tubes the construction is simpler and lighter, and cooling might be an option to prolong the service life (especially as these tubes exhibit excellent hot properties). The tubes can preferably be made of a material comprising silicon carbide (SiC), more preferably the material consists of silicon carbide.

For the support being ceramic tubes the tubes can be installed in the division wall and the side wall, e.g. side by side in a distance constant distance of 50-150 mm to each other. In this arrangement the ceramic tubes can be covered with ceramic plates (e.g. out of SiC, Mullite, Zirconiamullite) to build the floor of the inlet arrangement.

For a double pass vertical regenerator, in one embodiment the floor of the inlet arrangement for collection of carry over comprises ceramic tubes used as cooling tubes, preferably the ceramic tubes are made of silicon carbide. This has the effect that a prolonged lifetime and a reduced corrosion of both the ceramic tubes and the floor of the inlet arrangement for collection of carry over are achieved.

Both of ceramic tubes and sub crown structure show a good mechanical strength during operational conditions, in a surrounding with temperatures regularly exceeding 1400° C.

For a double pass vertical regenerator, in a special embodiment, the inlet arrangement for collection of carry over described above is arranged on top of the first pass of the regenerator and inside the housing of the regenerator such that gas entering the inlet arrangement for collection of carry over via the opening for the port is guided through the inlet arrangement for collection of carry over and exits the inlet arrangement for collection of carry over at the recess and through the second pass (e.g. long pass) of the regenerator and further through the first pass (e.g. the short pass) of the regenerator and exits the regenerator through the canal, when the regenerator is in the heating cycle.

All passes (e.g. first pass and the second pass (columns)) are filled with checkerwork (bricks). At the floor of the regenerator so called rider arches are used to support the checkerwork.

For a double pass vertical regenerator, the two passes are separated by the division wall. The division wall comprises an opening for a connection canal for gas exchange between the two passes. This opening of the division wall is situated at the lowermost end of the division wall (in other words at the floor of the regenerator). The rider arches and the opening of the divisional wall allow gas exchange between the two passes of the regenerator or in other words the regenerator comprises a connection canal which joints the first pass of the regenerator and the second pass of the regenerator through a space underneath the floor. The connection channel can have the same horizontal cross section area as the regenerator.

The vertical regenerator can also be a vertical regenerator comprising 3 or more passes.

The vertical regenerator can comprise two (e.g. symmetric) regenerator chambers, each regenerator chamber can comprise one, two or more passes.

Further benefits and advantages of the present invention will become apparent after a careful reading of the detailed description with appropriate reference to the accompanying drawings.

### BRIEF DESCRIPTION OF THE DRAWINGS

Exemplary embodiments are shown in the drawings:

FIG. 1a is a perspective view of a double pass vertical regenerator with an inlet arrangement for collection of carry over.

FIG. 1b is a perspective view of a single pass vertical regenerator with an inlet arrangement for collection of carry over.

FIG. 1c is a perspective view of a wire frame model of an inlet arrangement for collection of carry over.

FIG. 2 are side views of an inlet arrangement for collection of carry over in a regenerator showing different support means.

FIG. 3 shows side views of schematic dimensions of different embodiments of an inlet arrangement for collection of carry over.

FIG. 4 shows a schematic example of a checker geometry.

### DETAILED DESCRIPTION

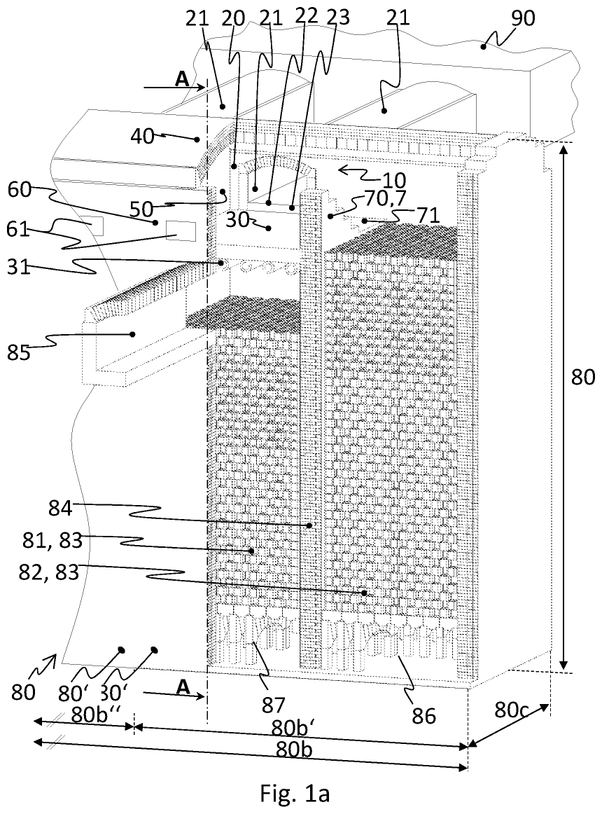

FIG. 1a shows one embodiment of a double pass vertical regenerator (80) for heat exchange with an end port furnace (90) comprising an inlet arrangement for collection of carry over (10). The end port furnace (90) is connected to a regenerator chamber (80b′) of the double pass vertical regenerator (80) via the port (21), such that gases can be exchanged between the end port furnace (90) and the regenerator (80). The end port furnace can be connected via a second port (21″) to a second regenerator chamber (80″, only partly shown) which has a mirrored design to the shown regenerator chamber (80′). In the heat cycle, hot flue gases from the end port furnace (90) enter the regenerator (80) via the opening (21a) for the port (21, 21″) of the inlet wall (20) into the inlet arrangement for collection of carry over (10). The inlet arrangement for collection of carry over (10) is positioned on the top of the regenerator (80) on top of a first pass (short pass) (81) of the regenerator (80). The inlet arrangement for collection of carry over (10) is a chamber (geometrically similar to a room) defined by several walls (20, 30, 40, 50, 60, 70), with two openings (21a, 71), namely an opening (21a) for a port (21, 21″) for gas exchange to an end-port furnace (90) and a recess (71) for gas exchange to the second pass (long pass) (82) of the regenerator (80). The opening to the end-port furnace (90) (called opening (21a) for the port (21, 21″)) is situated in the inlet wall (20) of the inlet arrangement for collection of carry over (10). The opening to the second pass (82) of the regenerator (10) is the recess (71) in the barrier wall (70) of the inlet arrangement for collection of carry over (10). The bottom of the inlet arrangement for collection of carry over (10) is built by the floor (30). The top of the inlet arrangement for collection of carry over (10) is built by the roof (40). The roof (40) can be built by the roof of the housing of the regenerator (80). The inlet arrangement for collection of carry over (10) further comprises a sidewall (50), which can be part of the main division wall (center wall) delimiting two regenerator chambers (80′, 80″). A target wall (60) can be opposite the inlet wall (20). A barrier wall (70) is positioned such, that it is aligned about 90° to the target wall (60). In this example the roof is an arched roof and all other walls are aligned to each other in a regular rectangular form, or in other words, all walls are arranged at an angle of 90° to each neighboring wall. In that case the inside of the inlet arrangement for collection of carry over (10) resembles a cuboid with an arched roof.

During the heat cycle the hot flue gas enters the inlet arrangement for collection of carry over (10) via the opening (21a) for the port (21, 21″) of the inlet wall (20) in the direction towards the target wall (60). The gas is deflected by and from the target wall and changes flow direction towards the recess (71) of the barrier wall (70) and finally leaves the inlet arrangement for collection of carry over (10) via the recess (71) and continues to flow through the second pass (82) of the regenerator (80) via a connection canal (86) (also called flue) formed by openings built by rider arches (87) and an opening (e.g. in the form of an arch) in the division wall (84) situated near the bottom of the regenerator (80) further to the first pass (81) of the regenerator (80). Both passes (81, 82) are filled with checkers/checkerwork bricks (83), which are refractory bricks, e.g. made of magnesia (magnesium oxide), MZS (magnesia zirconium silicate), mullite or AZS (alumina-zirconia-silica) fused cast material, zirconia mullite or chrome-alumina. The checkers (83) rest on top of the rider arches (87) which are situated at the bottom (the floor) of the regenerator (80). The passes (81, 82) are separated by a division wall (84), which comprises an opening in the form of an arch at the bottom of the regenerator (80), for gas exchange between the passes (81, 82). The hot flue gas transfers most of its thermal energy to the checkers (83) where the heat is stored (e.g. the checkers get hot). The flue gas exits the regenerator (80) via the canal (85).

When the hot flue gas changes its direction of flow from the incoming direction defined by the opening (21a) for the port (21, 21″) to the outgoing direction defined by the recess (71) particles and dust are separated from the gas stream. These particles hit the target wall (60) and some particles are absorbed and/or retained by this target wall (60), most particles loose most of their kinetic energy and fall down to the floor (30) of the inlet arrangement for collection of carry over (10), where they accumulate. The hot flue gas shows a greatly reduced amount of particles or dust upon exiting the inlet arrangement for collection of carry over (10) via the recess (71).

During the reverse cycle cold gas (e.g. external fresh air) enters the regenerator (80) via the canal (85) and flows through the first pass (81) via the connection canal (86) in the division wall (84) into the second pass (82) from where it enters the inlet arrangement for collection of carry over (10) via the recess (71) of the barrier wall (70). The hot checkers (83) of the regenerator passes (81, 82) heat up the incoming gas. The heated gas entering the recess (71) changes direction of flow towards the opening (21a) for the port (21, 21″) of the inlet wall (20) where it exits the inlet arrangement for collection of carry over (10) and the regenerator (80) towards an end-port furnace (90).

To further reduce the amount of particles to be transported back to the end-port furnace (90) a step (23) is introduced between the floor (30) of the inlet arrangement for collection of carry over (10) and the bottom edge (22) of the opening for the port (21, 21″).

For cleaning/removing dust and particle (carry over) accumulated on the floor (30) of the inlet arrangement for collection of carry over (10) holes for cleaning (61) are built into the target wall (60), which can be opened for cleaning and closed (by fixing plugs into the holes using mortar) for operation of the inlet arrangement for collection of carry over (10).

In FIG. 1a the cutting plane for section “A-A” is shown.

FIG. 1b shows one embodiment of a single pass vertical regenerator (80) for heat exchange with an end port furnace (90) comprising an inlet arrangement for collection of carry over (10). In a single pass vertical regenerator (80) only one pass (82) is present. The inlet arrangement for collection of carry over (10) is situated adjacent to the sidewall of the regenerator (80) or in other words that the barrier wall (70) of the inlet arrangement for collection of carry over (10) is built by a sidewall of the regenerator (80) housing. The recess (71) of the barrier wall is thus also a recess of the sidewall of the regenerator (70) housing. As shown in FIG. 1b the inlet arrangement for collection of carry over (10) is positioned at the top section of the regenerator (80). The same gas flow is achieved as in the embodiment for a double pass vertical regenerator (80) except that gas will exit the regenerator (80) after having passed through the only pass (82) through the canal (85) during the heat cycle.

FIG. 1c shows a wire frame model of one embodiment of an inlet arrangement for collection of carry over (10) with an inlet wall (20) with an opening (21a) for a port (21), a floor (30), a target wall (60) opposite of the inlet wall (20) with three cleaning holes (61), a barrier wall (70), the target wall (60) is arranged opposite of the inlet wall (20), and the barrier wall (70) is arranged at an angle of 90° relative to the target wall (60), the target wall (60) and the barrier wall (70) being connected along the full height (10d) in one corner of the inlet arrangement for collection of carry over (10), the barrier wall (70) defining a triangular barrier (72), the triangular barrier (72) is of the form of a right-angled triangle, with one leg aligned on the floor (30) and perpendicular to the target wall (70) and the second leg aligned on (along) the target wall (60) and perpendicular to the floor (30), the target wall (60) comprises three holes for cleaning (61), each hole for cleaning (61) has a rectangular cross-section with a side length in the range of 500 to 600 mm, the ratio R between the area A(wall) of the barrier wall (70) and the total area A(total) in the plane (73) of the barrier wall (70) limited by the inlet wall (20), the floor (30), the roof (40) and the target wall (60) is R=37.5%.

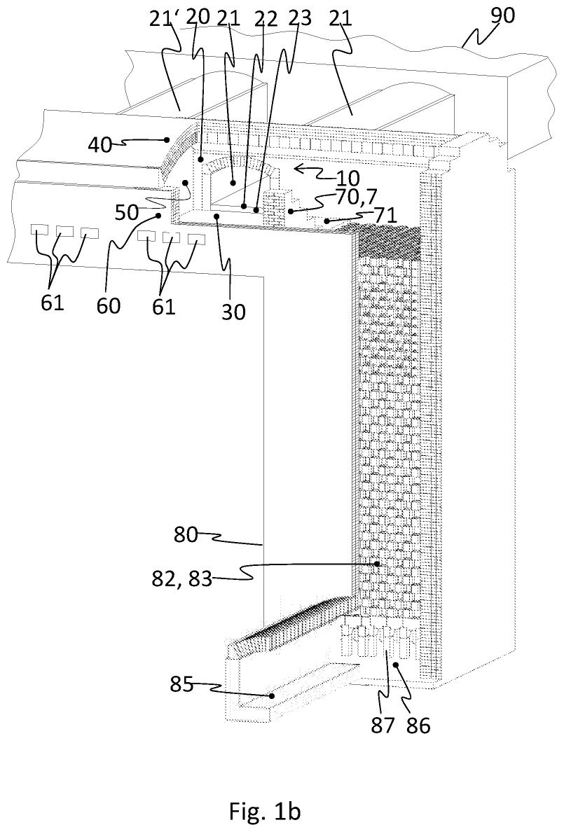

FIG. 2 shows a schematic section view (section “A-A”, compare FIG. 1) of an inlet arrangement for collection of carry over (10) in a regenerator (80) with the barrier wall (70), building a barrier (72) and a recess (71) for gas exchange. The floor (30) of the inlet arrangement for collection of carry over (10) rests on a support (31) which is connected to the housing of the regenerator (80). The support (31) can be ceramic tubes (32) as shown in FIG. 2a or a sub crown structure (33) as shown in FIG. 2b.

For the construction with ceramic tubes (32) SiC tubes (e.g. Hexoloy® SE Silicon Carbide from Saint Gobain) can be used. These tubes exhibit excellent hot properties and can have exemplary dimensions of 4600 mm length and 19 mm diameter. The division wall (84) and the side wall (50) act as carrier for these tubes (32), which can be installed side by side in a distance of e.g. 100 mm to each other. In order to build the floor (30) this arrangement of ceramic tubes (32) can be covered with ceramic plates (e.g. out of SiC, Mullite, Zirconiamullite).

In one embodiment of the invention the inlet arrangement for collection of carry over (10) comprises a barrier wall (70) that forms a right angled triangular barrier (72) for the gas exchange, where one leg of the triangular barrier (72) is aligned with the target wall (60) and perpendicular to the floor (30), thereby forming the corner between the barrier wall (70) and the target wall (60) and the second leg is aligned with the floor (30) of the inlet arrangement for collection of carry over (10) and perpendicular to the target wall (70).

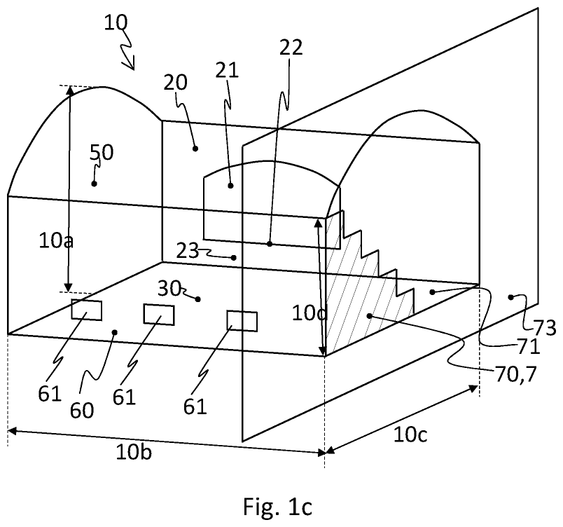

FIG. 3 shows possible different versions of this embodiment, where exemplary the floor (30) of the inlet arrangement for collection of carry over (10) is built by a support (31) being ceramic tubes (32), according to the embodiment shown in FIG. 2a. Alternatively, for all examples of FIG. 3, the support (31) can be a sub crown structure (33) according to FIG. 2b. The triangular barrier (72) has a height (length a) and a base (length b).

FIG. 3a and FIG. 3b shows that the height (length a) of the barrier (72) can be the same as the height (10d) of the inlet arrangement for collection of carry over (10) in the corner between the barrier wall (70) and the target wall (60) or in other words the target wall (60) and the barrier wall (70) are connected along the full height (10d) in one corner of the inlet arrangement for collection of carry over (10).

FIG. 3c and FIG. 3d shows that the height (length a) of the barrier (72) can be smaller than the height (10d) of the inlet arrangement for collection of carry over (10) in the corner between the barrier wall (70) and the target wall (60).

FIG. 3a and FIG. 3c shows that the base (length b) of the barrier (72) can be the same as the dimension of the inlet arrangement for collection of carry over (10) along the intersection of the floor (30) with the barrier wall (70).

FIG. 3b and FIG. 3d shows a smaller base (length b) of the barrier (72) than the dimension of the inlet arrangement for collection of carry over (10) along the intersection of the floor (30) with the barrier wall (70), for example the base can be in the range of 70% to 80% of the dimension of the inlet arrangement for collection of carry over (10) along the intersecting line of the barrier wall (70) with the floor (30).

The best results were achieved using a right angled barrier (72) as shown in FIG. 3b, having the same height (length a) as the height (10d) of the inlet arrangement for collection of carry over (10) in the corner between the barrier wall (70) and the target wall (60) and having a base (length b) in around ¾ (e.g. 73 to 77%) of the dimension of the inlet arrangement for collection of carry over along the intersecting line of the barrier wall (70) with the floor (30). In this embodiment most particles/dust was kept away from the checker (83) and the best thermal efficiency was reached, probably due to a favorable distribution of the gas stream.

The dimensions of the regenerator (80) in this embodiment are as follows: 12 m height (80a), 13.6 m width (80b) with two chambers of 6.8 m width (80b′ and 80b″; each chamber accounting for two passes with the same horizontal cross-section, each with a width of 3.4 m), 4.6 m depth (80c), each chamber having 2 passes (81, 82), with a connection canal (86) (sometimes called a flue; 6.8 m long, 1.5 m height, 4.6 m depth) which connects both passes (81, 82) at the bottom. The connection canal (86) joints the first pass (81) of each regenerator chamber (80′, 80″) of the regenerator (80) and the second pass (82) of each regenerator chamber (80′, 80″) of the regenerator (80) through a space underneath the rider arches (87), having the same horizontal cross section area (or in other words the ground area) as each regenerator chamber (80′, 80″) of the regenerator (80) and having 1.5 meter height.

The refractory checkerwork layout in this example is as follows:

For the second pass (82): 45 rows (layers) of checkers (83) of standard chimney block format (checker brick made out of MgO, RHI brand Anker DG1), on top: two layers of zirconia mullite bricks, RHI brand DURITAL AZ58.

For the short pass (81): 34 layers of checkers (83) of standard chimney block (AZS bricks, RHI brand Rubinal EZ).

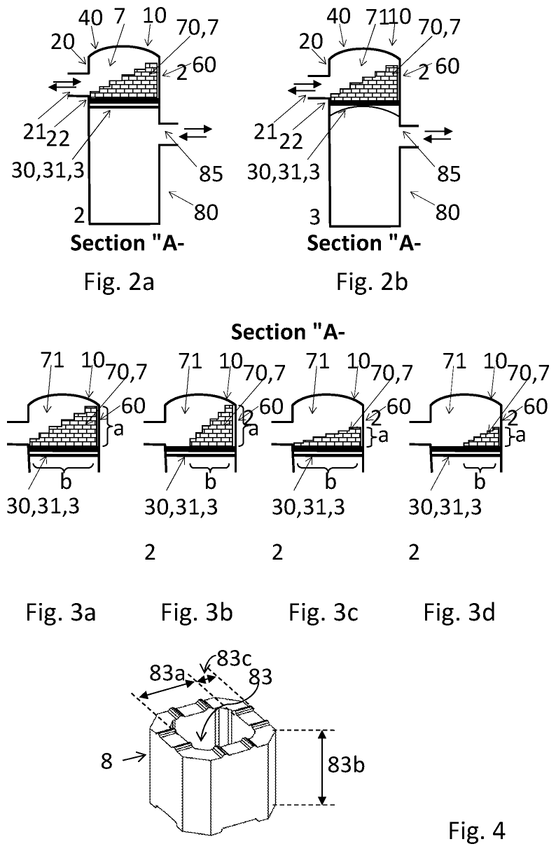

Each checker (83) with the standard chimney block geometry has 140 mm flue size (83a) (this is the inner dimension of the checkers (83)), 175 mm height (83b), 38 mm wall thickness (83c). A schematic example of such a checker (83) is shown in FIG. 4. Generally, the checker has (in its use position in a vertical regenerator (80)) a so called flue channel (83d) allowing a hot gas to flow inside the checker (83) in a vertical direction.

The dimension of the inlet arrangement for collection of carry over (10) in this embodiment are as follows: 2.1 m height (10a), 3.4 m width (10b), 4.6 m depth (10c) (floor dimensions are the same as for one pass (81) of each regenerator chamber (80′, 80″) of the regenerator (80)), and 1.5 m height (10d) in the corner between the barrier wall (70) and the target wall (60) and with a barrier wall (70) defining a barrier (72) of 3.5 m base (length b; 76% of 4.6 m depth 10c)) and 1.5 m height (length a) in the corner between the barrier wall (70) and the target wall (60) thus defining an area A(barrier)=2.6 m², A(recess)=6.2 m² and A(total)=8.8 m²; thus a ratio of A(barrier)/A(total)=29.5% The inlet wall (20), the floor (30), the roof (40), the sidewall (50), the target wall (60) and the barrier wall (70) are all composed of bricks of mullite (RHI brand Durital S70) and define a arched cuboid of volume 30 m³ (volume of cuboid plus arched space).

One specific embodiment is an inlet arrangement for collection of carry over (10) for a vertical regenerator (80) of an end-port furnace (90) comprising:
an inlet wall (20) comprising an opening fora port (21, 21″) for gas exchange towards an end-port furnace (90),
a floor (30),
a target wall (60) being arranged such, that most of the via the inlet wall(20) incoming hot gas is initially deflected at the target wall (60),
a barrier wall (70) comprising a recess (71) for gas exchange towards a pass (82) of the regenerator (80),
a roof (40),
a sidewall (50),
the inlet wall (20), the floor (30), the roof (40), the sidewall (50), the target wall (60), the barrier wall (70) defining the inlet arrangement for collection of carry over (10) such that a gas flow entering the inlet arrangement for collection of carry over (10) via the opening for a port (21, 21″) will exit the inlet arrangement for collection of carry over (10) via the recess (71) or vice versa
   wherein the target wall (60) is arranged opposite of the inlet wall(20), and the barrier wall (70) is arranged at an angle between 80° to 100° relative to the target wall (60),
   and the target wall (60) comprises at least one hole for cleaning (61),
   and each hole for cleaning has a square or rectangular cross-section with a side length in the range of 250 to 700 mm, preferably 500 mm to 700 mm,
   and the target wall (60) and the barrier wall (70) being connected along one corner of the inlet arrangement for collection of carry over (10),
   and the target wall (60) and the barrier wall (70) being connected along the full height (10d) in one corner of the inlet arrangement for collection of carry over (10), and the ratio between the area of the barrier wall (70) and the total area in the plane (73) of the barrier wall (70) limited by the inlet wall (20), the floor (30), the roof (40) and the target wall (60) is in the range of 20% to 40%, preferably in the range of 30% to 38%, and the barrier wall (70) defines a triangular barrier (72), and the triangular barrier (72) is of the form of a right-angled triangle, with one leg aligned on the floor(30) and the second leg aligned on the target wall (60), and the floor (30) of the inlet arrangement for collection of carry over (10) being at a lower elevation than the bottom edge (22) of the opening for the port (21, 21″) such that a step (23) is introduced between the floor (30) of the inlet arrangement for collection of carry over (10) and the bottom edge (22) of the opening for the port,
   and the step (23) has a step height in the range 50 cm to 90 cm, more preferably in the range of 70 cm to 90 cm,
   and all walls of the inlet arrangement for collection of carry over (10) are planar, vertical walls,
   and the floor (30) of the inlet arrangement for collection of carry over (10) is arranged on top of first pass (81) of the regenerator (80) and is built on a support (31) connected to the housing of the regenerator (80).

Another embodiment is a Regenerator assembly comprising an inlet arrangement for collection of carry over (10), preferably according to the specific embodiment above, and a double pass vertical regenerator (80),

wherein the floor (30) of the inlet arrangement for collection of carry over (10) is arranged on top of first pass (81) of the regenerator (80) and is built on a support (31) connected to the housing of the regenerator (80),
and the support (31) are ceramic tubes (32) or a sub crown structure (33), and the inlet arrangement for collection of carry over (10) is arranged on top of the first pass (81) of the regenerator (80) and inside the housing of the regenerator (80) such that gas entering the inlet arrangement for collection of carry over (10) via the opening for the port (21, 21″) is guided through the inlet arrangement for collection of carry over (10) and exits the inlet arrangement for collection of carry over (10) at the recess (71) of the barrier wall (70) of the inlet arrangement for collection of carry over (10) and through the second pass (82) of the regenerator (80) and further through the first pass (81) of the regenerator (80) and exits the regenerator (80) through the canal (85).

### LIST OF REFERENCE CHARACTERS

10 Inlet arrangement for collection of carry over
10a full height of inlet arrangement for collection of carry over
10b width of inlet arrangement for collection of carry over
10c depth of inlet arrangement for collection of carry over
10d height of inlet arrangement for collection of carry over in the corner between the barrier wall and the target wall
20 inlet wall of inlet arrangement for collection of carry over
21, 21″ port
21a opening for a port
22 bottom edge of opening for the port
23 step
30 floor of inlet arrangement for collection of carry over
31 support
32 ceramic tubes
33 sub crown structure
40 roof of the inlet arrangement for collection of carry over
50 sidewall of the inlet arrangement for collection of carry over
60 target wall of the inlet arrangement for collection of carry over
61 holes for cleaning
70 barrier wall of the inlet arrangement for collection of carry over
71 recess
72 barrier
73 plane of the barrier wall
80 vertical regenerator
80′, 80″ regenerator chambers
80a height of the vertical regenerator
80b width of the vertical regenerator
80b′, 80b″ width of the regenerator chambers
80c depth of the vertical regenerator
81 first pass (short pass) of regenerator (chamber)
82 second pass (long pass) of regenerator (chamber)
83 checkerwork bricks (checkers)
83a flue size of checkerwork brick
83b height of checkerwork brick
83c wall thickness of checkerwork brick
83d flue channel
84 division wall
85 canal
86 connection canal
87 rider arches
90 end-port furnace

1. Inlet arrangement for collection of carry over (10) for a vertical regenerator (80) of an end-port furnace (90) comprising:
an inlet wall (20) comprising an opening for a port (21, 21″) for gas exchange towards an end-port furnace (90);
a target wall (60) being arranged such that most of the hot gas incoming via the inlet wall (20) is initially deflected at the target wall (60);
a barrier wall (70) comprising a recess (71) for gas exchange towards a pass (82) of the regenerator (80);
a delimiting wall or delimiting walls (30, 40, 50), such as a floor (30) and/or a roof (40) and/or a sidewall (50);
the inlet wall (20), the target wall (60), the barrier wall (70) and the delimiting wall or walls (30, 40, 50) define the inlet arrangement for collection of carry over (10) such that a gas flow entering the inlet arrangement for collection of carry over (10) via the opening for a port (21, 21″) will exit the inlet arrangement for collection of carry over (10) via the recess (71) or vice versa;
characterized in that,
the ratio between the area of the barrier wall (70) and the total area in the plane (73) of the barrier wall (70), limited by the delimiting wall or walls (30, 40, 50), such as the floor (30), the roof (40), the inlet wall (20) and the target wall (60), is in the range of 20% to 40%.

2. Inlet arrangement for collection of carry over (10) according to claim 1, characterized in that the target wall (60) is arranged opposite of the inlet wall(20), and the barrier wall (70) is arranged at an angle between 80° to 100° relative to the target wall (60).

3. Inlet arrangement for collection of carry over (10) according to claim 1, characterized in that the target wall (60) comprises at least one hole for cleaning (61).

4. Inlet arrangement for collection of carry over (10) according to claim 3, characterized in that each hole for cleaning has a square or rectangular cross-section with a side length in the range of 250 to 700 mm, preferably 500 mm to 700 mm.

5. Inlet arrangement for collection of carry over (10) according to claim 1, characterized in that the target wall (60) and the barrier wall (70) being connected along one corner of the inlet arrangement for collection of carry over (10).

6. Inlet arrangement for collection of carry over (10) according to claim 1, characterized in that the target wall (60) and the barrier wall (70) being connected along the full height (10d) in one corner of the inlet arrangement for collection of carry over (10).

7. Inlet arrangement for collection of carry over (10) according to claim 1, characterized in that the barrier wall (70) defines a triangular barrier (72).

8. Inlet arrangement for collection of carry over (10) according to claim 7, characterized in that the delimiting wall or walls (30, 40, 50) comprises a floor (30), the triangular barrier (72) is of the form of a right-angled triangle, with one leg aligned on the floor(30) and the second leg aligned on the target wall (60).

9. Inlet arrangement for collection of carry over (10) according to claim 1, characterized in that the further delimiting walls (30, 40, 50) comprises a floor (30), the floor (30) of the inlet arrangement for collection of carry over (10) being at a lower elevation than a bottom edge (22) of the opening for the port (21, 21″) such that a step (23) is introduced between the floor (30) of the inlet arrangement for collection of carry over (10) and the bottom edge (22) of the opening for the port.

10. Inlet arrangement for collection of carry over (10) according to claim 9, characterized in that the step (23) has a step height in the range 50 cm to 90 cm.

11. Inlet arrangement for collection of carry over (10) according to claim 1, characterized in that all walls of the inlet arrangement for collection of carry over (10) are planar, vertical walls.

12. Regenerator assembly comprising an inlet arrangement for collection of carry over (10) according to claim 1, characterized in that the further delimiting walls (30, 40, 50) of the inlet arrangement for collection of carry over (10) comprises a floor (30), the floor (30) of the inlet arrangement for collection of carry over (10) is arranged on top of a first pass (81) of a regenerator (80) and is built on a support (31) connected to the housing of the regenerator (80).

13. Regenerator assembly according to claim 12, characterized in that the support (31) are ceramic tubes (32) or a sub crown structure (33).

14. Regenerator assembly according to claim 12, characterized in that the inlet arrangement for collection of carry over (10) is arranged on top of the first pass (81) of the regenerator (80) and inside the housing of the regenerator (80) such that gas entering the inlet arrangement for collection of carry over (10) via the opening for the port (21, 21″) is guided through the inlet arrangement for collection of carry over (10) and exits the inlet arrangement for collection of carry over (10) at the recess (71) of the barrier wall (70) of the inlet arrangement for collection of carry over (10) and through the second pass (82) of the regenerator (80) and further through the first pass (81) of the regenerator (80) and exits the regenerator (80) through the canal (85).
